(19) United States
(12) Patent Application Publication
(10) Pub. No.: US 2015/0183961 A1
(43) Pub. Date: Jul. 2, 2015

(54) Biomass Processing

(71) Applicant: Mahesh Talwar, Somis, CA (US)

(72) Inventor: Mahesh Talwar, Somis, CA (US)

(21) Appl. No.: 14/510,298

(22) Filed: Oct. 9, 2014

Related U.S. Application Data
(63) Continuation-in-part of application No. 14/140,766, filed on Dec. 26, 2013.
Application No. 14/140,766 is a continuation-in-part of application No. 14/140,956, filed on Dec. 26, 2013.

(51) Int. Cl. C08K 9/00; C10L 1/02; C08L 95/00; C10L 1/182

(52) U.S. Cl. CPC C08K 9/00; C10L 1/1824; C10L 1/02; C08L 95/00; C10L 2290/08; C10L 2290/24; C10L 2200/0469

(57) ABSTRACT

A biomass processing system produces a refined bio oil. The system includes a first auger carrying the biomass through a torrefaction/drying chamber to dry the biomass and a second auger carries biomass feed material though the torrefaction/drying chamber to produce vapor phase bio oil. The vapor phase bio oil is collected carried from the torrefaction/drying chamber to condensers and quenched by a water spray before release into the condensers. The water spray also serving as a solvent to reduce pH in the liquid phase raw bio oil. The raw bio oil is carried to a conditioning system where the raw bio oil resides in a separation tank where the water separates and is removed producing refined bio oil. Ethanol may be mixed with the refined bio oil to produce fuel oil or petroleum asphalt may be mixed with the refined bio to obtain a substitute for road asphalt.

The present application is a Continuation In Part of U.S. patent application Ser. No. 14/140,766 filed Dec. 26, 2013 and U.S. patent application Ser. No. 14/140,956 filed Dec. 26, 2013, which applications are incorporated in their entirety herein by reference.

### BACKGROUND OF THE INVENTION

### Background of the Invention

The present invention relates to biomass bio oil and in particular to a method for converting biomass feed material into a useful fuel oil or a useful road asphalt.

Biomass is comprised mainly of cellulose, hemi cellulose and lignin. A typical woody biomass may contain 40-50% cellulose, 25-35% hemi cellulose, and 15-18% lignin. Typical yields from a slow pyrolysis machine are 30% charcoal containing 70% plus carbon, 35% non-condensable gases containing hydrogen, methane, carbon mono oxide, carbon dioxide primarily, and 35% pyrolysis oil, also known as bio oil or bio crude, consisting tar, aldehydes, formic acid, acetic acid, water, esters, phenols, sugar derivatives, lignins. Such typical slow pyrolysis machine yields oil and charcoal in nearly equal portions. Slow pyrolysis involves heating of dried biomass (<8% moisture) in an oxygen free environment at 450-500 degrees centigrade in heated auger tubes. The process involves thermo chemical conversion of solid biomass to a liquid product, bio oil, and solid material, charcoal. Non condensable gases are utilized to heat the incoming wet biomass material, thus creating a closed loop system.

Convention slow pyrolysis process yields bio oil that has the following properties:

Chemical formula: CH_{1.3}O_{0.47}

Flash point: 80 deg C.

pH=2.5

Sp Gr.=1.2

Moisture content: 20-25%

Heating value=7,522 btu/lb (17.5 mj/kg)

Viscosity=60-100 cp

and

### Elemental Analysis:

C=55-60%

H=5-8%

O=28-40%

N=0.06%

Unfortunately, there are several issues with the use of such bio oil as a heating oil. The bio oil has a very low pH. Formation of acetic acid and formic acid during the pyrolysis process (derived mainly from the hemi cellulose portion of the wood) are the cause of low and highly acidic pH which makes it difficult to use this fuel with carbon steel, aluminum and natural rubber due to corrosion issues. To avoid corrosion issues, pH of the fuel should be close to neutral 7. The viscosity of bio oil can be as high as 100 cp and as a result can cause issues with the spray nozzles, fuel pumps, and other fuel handling equipment. Very heavy fuel oil such as Bunker C can have very high viscosity, however, upon heating; the viscosity of heavy petroleum fuels goes down to acceptable levels. Heating of bio oil leads to polymerization and hardening of fuel, thus making the problem worse. Additionally, the bio oil is immiscible with all petroleum fuels, so it cannot be mixed with other low viscosity fuel oils to lower its viscosity either. Over time, the bio oil starts to degrade due to the polymerization reactions. It becomes more viscous and water starts to separate out. This phenomenon can happen in as little as 30 days. Viscosity can increase tenfold at times. Heating value of bio oil is approximately 45% of that of fuel oil due to the presence of high levels of oxygen and water.

Other attempted uses of bio oil include utilization as a substitute for road asphalt, also known as hot mix asphalt. Asphalt is currently derived from petroleum sources. Road asphalt may contain certain additives to prevent cracking, providing elasticity, and increased weather resistance. Raw bio oil, when heated, would indeed polymerize and harden; however, it still does not harden enough for use as road asphalt. Asphalt application for road requires that the asphalt harden within 24 hours to resume traffic, bio oil's utilization as asphalt does not contain this quick hardening property.

Further, rotary dryers are commonly used to dry biomass. There are several variations of rotary dryers, but the most widely-used is the directly heated single-pass rotary dryer. The directly heated single-pass rotary dryer uses hot gases contacting the biomass material inside a rotating drum. The rotation of the drum, with the aid of flights, lifts the solids in the dryer so they tumble through the hot gas, promoting better heat and mass transfer. The biomass and hot air normally flow co-currently through the dryer so the hottest gases come in contact with the wettest material. The exhaust gases leaving the dryer may pass through a cyclone, multicyclone, bag house filter, scrubber or electrostatic precipitator (ESP) to remove any fine material entrained in the air. An ID fan may or may not be required depending on the dryer configuration. If an ID fan is needed, it is usually placed after the emissions control equipment to reduce erosion of the fan, but may also be placed before the first cyclone to provide the pressure drop through downstream equipment. The inlet gas temperature to rotary biomass dryers can vary from 450°-2,000° F. (232°-1,093° C.). Outlet temperatures from rotary dryers vary from 160° to 230° F. (71°-110° C.), with most of the dryers having outlet temperatures higher than 220° F. (104° C.) to prevent condensation of acids and resins. Retention times in the dryer can be less than a minute. While known dryers generally perform adequately, they require a dedicated facility and energy source increasing the cost of processing the biomass material.

### BRIEF SUMMARY OF THE INVENTION

The present invention addresses the above and other needs by providing a biomass processing system which produces a refined bio oil. The system includes a first auger carrying the biomass through a torrefaction/drying chamber to dry the biomass and a second auger carries biomass feed material though the torrefaction/drying chamber to produce vapor phase bio oil. The vapor phase bio oil is collected carried from the torrefaction/drying chamber to condensers and quenched by a water spray before release into the condensers. The water spray also serving as a solvent to reduce pH in the liquid phase raw bio oil. The raw bio oil is carried to a conditioning system where the raw bio oil resides in a separation tank where the water separates and is removed producing refined bio oil. Ethanol may be mixed with the refined bio oil to produce fuel oil or petroleum asphalt may be mixed with the refined bio to obtain a substitute for road asphalt.

In accordance with one aspect of the invention, there is provided a pyrolysis system including quenching of bio oil in vapor phase. Longer residence times of vapors from a torrefaction/drying chamber in the presence of charcoal tend to increase tar formation. To reduce such tar formation, vapors coming from the torrefaction/drying chamber are quickly quenched by a spray of cooling water. Other oils, for example, bio diesel or the pyrolysis oil itself, may be used as a cooling medium, however, the use of water is beneficial for the following step explained below. Reduction in tar formation helps keep the viscosity of the bio oil lower and prevents clogging of the lines and equipment from tar formation.

In accordance with another aspect of the invention, bio oil pH is reduced by removing water soluble formic and acetic acids from the bio oil using water as a solvent. Experiments with varying amounts of water found that water addition in the amount of 40-50 percent in the liquid phase bio oil by volume results in the formation of two district phases, an aqueous phase and an oil phase, with the aqueous phase floating to the top. Additionally, the aqueous phase pulls the water soluble acidic constituents of raw bio oil resulting in a refined bio oil. The aqueous phase is drained providing the refined bio oil for further processing. The pH of the aqueous phase is generally about 2.5, while the pH of the refined bio oil is generally about 6.2. The water added during the quenching process thus provides two advantages: a) better contact of water and oil and b) a cooling medium at the same time.

In accordance with yet another aspect of the invention, the bio oil is mixed with at least 20% ethanol (i.e., one part bio oil and at least 0.2 parts ethanol) and preferably the bio oil is mixed with at about 20% ethanol. Bio oil is soluble in ethanol. Viscosity of bio oil obtained from mixing of ethanol is reduced to 4-5 cp which makes it very comparable to that of fuel oil. The bio oil can now be used as fuel without heating. Methanol may be used, but ethanol is renewable and has a higher heating value of compared to methanol. Additionally, stability of bio oil was enhanced with the addition of ethanol. Ethanol also has a higher flash point compared to methanol and is therefore easier and safer to handle. Due to the solvent nature of ethanol, no water separation has been observed and the bio oil remains in homogeneous phase with no increase in viscosity for the observation period of six months. Additional of ethanol also helps as an ignition improver. Ethanol also helps improve clogging in lines and keeps the storage and contact surfaces clean.

In accordance with still another aspect of the invention, the heating value of the bio oil is increased from 17.5 kj/kg to 22.5-25 kj/kg, thus making the bio oil closer to petroleum fuel oils and a viable fuel.

In accordance with another aspect of the invention, a combination of quench, water extraction, ethanol addition resulted in fuel that has higher pH, more stable, extremely low viscosity, stable and useable as a heating fuel (closer to #4 fuel oil) without needing any external heating. The heating value of bio oil unexpectedly increased about 25%, providing a commercial viability bio oil.

In accordance with yet another aspect of the invention, there is provided a substitute for road asphalt, also known as hot mix asphalt. Currently, asphalt is derived from petroleum sources. Road asphalt may contain certain additives to prevent cracking, providing elasticity, and increased weather resistance. There are several issues with the use of Raw Bio Oil: Raw bio oil when heated would indeed polymerize and harden; however, it still does not harden enough for use as road asphalt. Asphalt application for road also require that the asphalt harden within 24 hours to resume traffic, bio oil's utilization as asphalt does not contain this quick hardening property. The substitute for road asphalt is obtained using refined bio oil, which is essentially devoid of acidic components to reduce pH, mixed with an equal or greater amount of petroleum asphalt. Such a mixture unexpectedly hardens and behaves like a standard asphalt. Greater amounts of petroleum asphalt may be used if desired. A secondary benefit is that using of raw bio oil as a road asphalt ingredient also imparted a shiny glow to the surface which improves appearance.

In accordance with another aspect of the invention, there is provided a method for processing bio mass. The method includes feeding biomass material into an oxygen rare torrefaction/drying chamber, heating the biomass material to create vapor phase bio oil, carrying vapor phase bio oil from the torrefaction/drying chamber to a condenser, quenching the vapor phase bio oil before releasing into the condenser, cooling the vapor phase bio oil in the condenser, condensing the vapor phase bio oil into liquid phase raw bio oil in the condenser, separating water from the raw bio oil to produce refined bio oil, and mixing ethanol with the refined bio oil to produce a fuel oil.

In accordance with another aspect of the invention, there is provided a method for drying biomass material in a first pass through the torrefaction/drying chamber. The biomass material is released into a first auger through an airlock. The first auger carries the raw biomass though the torrefaction/drying chamber drying the biomass material. At an opposite end of the first auger, the dried biomass material is releases to drop into a second auger for a second pass through the torrefaction/drying chamber to create vapor phase bio oil.

In accordance with another aspect of the invention, there is provided a method for processing bio mass. The method includes feeding biomass material into an oxygen rare torrefaction/drying chamber, drying the biomass material in a first pass through the torrefaction/drying chamber in a first auger, releasing the dried biomass material into a second auger, continue heating the dried biomass material in a second pass through the torrefaction/drying chamber in the second auger to create vapor phase bio oil, carrying vapor phase bio oil from the torrefaction/drying chamber to a condenser, quenching the vapor phase bio oil before releasing into the condenser, cooling the vapor phase bio oil in the condenser, condensing the vapor phase bio oil into liquid phase raw bio oil in the condenser, separating water from the raw bio oil to produce refined bio oil, and either mixing ethanol with the refined bio oil to produce a fuel oil, or mixing petroleum asphalt with the refined bio oil to produce a substitute for road asphalt.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a pyrolysis system for producing bio oil according to the present invention.

FIG. 2 is a bio oil conditioning system according to the present invention.

FIG. 3 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

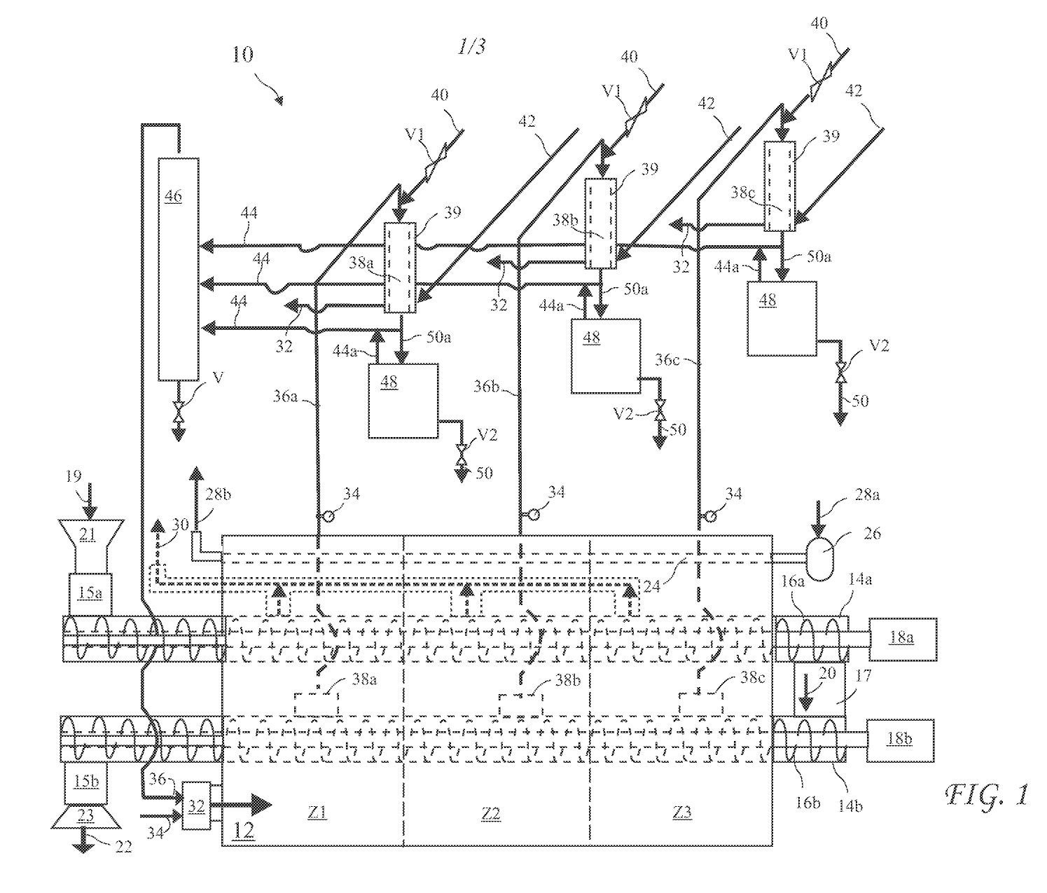

A pyrolysis system 10 for producing bio oil according to the present invention is shown in FIG. 1. The pyrolysis system 10 primarily includes a torrefaction/drying chamber 12 containing augers 16a and 16b residing in first and second auger housings, a drying/torrefaction tube 14a and a carbonizing tube 14b respectively, extending through the length of the torrefaction/drying chamber 12. The augers 16a and 16b are rotated by a motors 18a and 18b respectively. Biomass feed material 19, for example dry sawdust, is fed through an entry 21 into the drying/torrefaction tube 14a at one end of the torrefaction/drying chamber 12. The Biomass feed material 19 passes through a first airlock 15a, for example, a rotating vane inside a chamber which traps material in one cavity and releases it downward, and into the drying/torrefaction tube 14a. The Biomass feed material 19 makes a first pass through the torrefaction/drying chamber 12 and is dried. At the end of the first pass, the dried biomass material 20 is released through a chute 17 into the carbonizing tube 14b.

The dried biomass material 20 is carried back through the torrefaction/drying chamber 12 and charcoal material 22 is released from the auger housing 14b through a chute 23 at an opposite end of the torrefaction/drying chamber 12. The interior of the torrefaction/drying chamber 12 is substantially oxygen free and at a high temperature, causing the dried biomass material 20 to release vapors phase bio oil into the interior of the torrefaction/drying chamber 12. A hot air tube 24 runs through the torrefaction/drying chamber 12 above the auger housings 14a and 14b carrying ambient air 28a heated and pumped by heater 26 and released on the opposite end of the torrefaction/drying chamber 12. The exhaust 28b from the hot air tube 24 may be directed to dry incoming biomass material 19 or to dry the wet briquettes produced in a briquetting section of the facility including the pyrolysis system 10. Drying tube exhaust 30 is collected from all three zones Z1, Z2, and Z3 and vented to the atmosphere.

The vapor phase bio oil generated in the torrefaction/drying chamber 12 is collected in condensers 38a, 38b, and 38c and vapor flows 36a, 36b, and 36c respectively are carried to double wall condensers 38. The condensers 38a, 38b, and 38c receive the vapor phase bio oil from sections of the carbonizing tube 14b residing in the three zones Z1, Z2, and Z3 of the torrefaction/drying chamber 12. The first zone, zone Z1, is approximately the first third of the torrefaction/drying chamber 12 length which will allow the collection of mostly moisture vaporized along with some very light ends. The second zone, zone Z2, is approximately the second third of the torrefaction/drying chamber 12 length to collect light vapors and acid constituents vapors along with the reaction water. The third zone, zone Z3, is approximately the last third of the torrefaction/drying chamber 12 length to collect heavier vapors, for example, vapor phase tar. The multiple collectors 38a, 38b, and 38c allow product segregation from light to heavy ends in addition to keeping the water content of light and heavy liquid products low. Additionally, the multiple collectors 38a, 38b, and 38c allow for heavy liquid to have pH closer to 6 rather than 2.5. The light liquid will have pH of 2.5 but the absence of tar in that allows lowering of pH by conventional means, such as addition of alkali.

Temperature indicators 34 monitor the temperature of the vapor flows 36. Quench water 40 is introduced into the vapor phase bio oil flows 36a, 36b, and 36c through valves V1 before the vapors enter the condensers 38a, 38b, and 38c, and cooling water 42 is provided between the double walls 39 of the condensers 38a, 38b, and 38c to cool the vapor phase bio oil flows 36a, 36b, and 36c passing through the centers of the double wall condensers 38a, 38b, and 38c, the cooling water 42 exits the condensers 38a, 38b, and 38c as flows 32. The amounts of quench water 40 is controlled to obtain desired properties of a liquid phase bio oil 50a and 50. Quench water 40 also acts as solvent to extract acidic components from the liquid phase bio oil 50a and 50 which makes the bio oil more transportable and stable.

The amounts of quench water 40 provided is preferably determined by the biomass feed material 19 feed rate into the torrefaction/drying chamber 12. The rate which the biomass feed material 19 is fed into the torrefaction/drying chamber 12 is monitored and an expected production of refined bio oil 86 is calculated. The refined bio oil 86 production is generally about 35 percent by weight of the biomass feed material 19. The rate of providing the quench water 40 is preferably controlled to result in a mixture 40 to 50 percent by volume of the quench water 40 and 50 to 60 percent by volume of bio oil in the raw bio oil 50.

Condensed bio oil 50a drains from the condensers 38a, 38b, and 38c into storage tanks 48. Condensed water 44 collected between the condensers 38a, 38b, and 38c and the storage tanks 48, and condensed water 44a from storage tanks 48, is carried to a water Knock Out (KO) drum 46. Raw bio oil 50a is released from the storage tanks 48 through second valves V2.

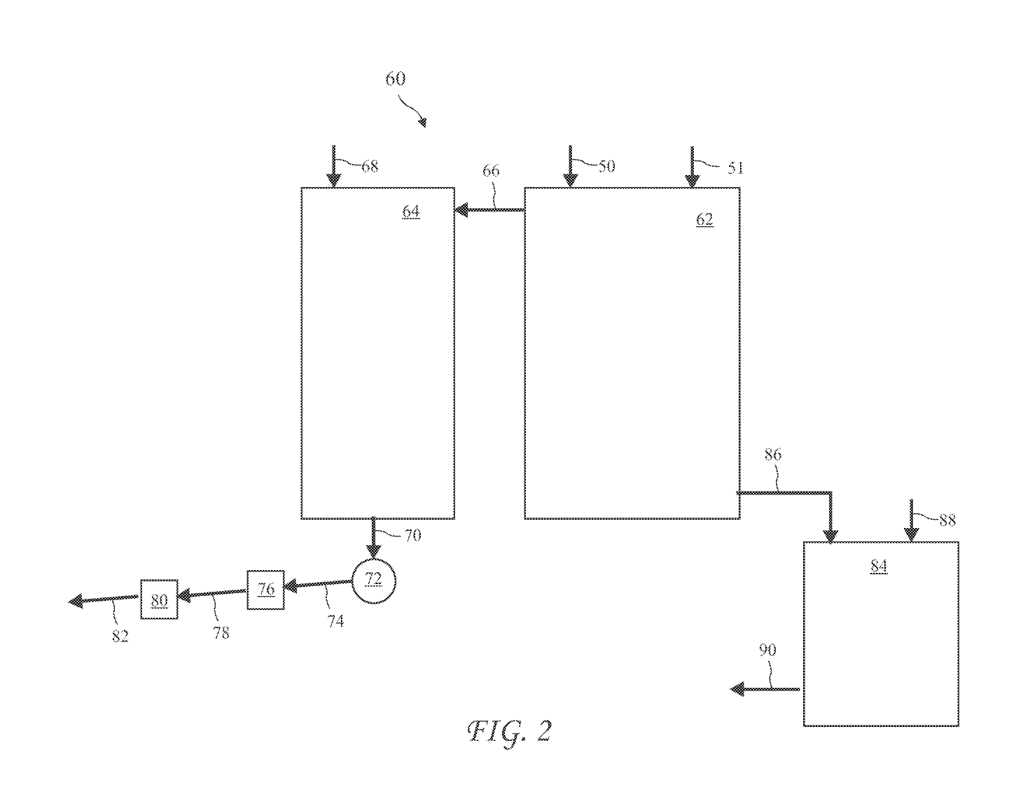

FIG. 2 is a bio oil fuel conditioning system 60 according to the present invention. The bio oil fuel conditioning system 60 includes an oil/water separator 62 which receives the raw bio oil 50 from the storage tanks 48 and separates water from the raw bio oil 50 to produce refined bio oil 86. The water 66 is transferred to a pH balance tank 64 which also receives a pH control additive 68 to produce pH balanced water, The pH balanced water 70. The pH balance water 70 is pumped by pump 72 from the pH balance tank 64 through a filter 76 to produces filtered water 78, and through a cooler 80 to produce cooled water 82, and to a cooled water supply. Optionally, additional water 51 may be added to the oil/water separator 62 if necessary as a solvent.

In one embodiment, separated refined bio oil 86 is carried to a mixing tank 84 where ethanol 88 is mixed with the refined bio oil 86 to create a useful fuel oil 90. An amount of ethanol 88 equal to at least 20 percent by volume of the refined bio oil 86, is mixed with the refined bio oil 86 to produce a useful fuel oil.

In another embodiment, separated refined bio oil 86 is carried to a mixing tank 84 where petroleum asphalt 89 is mixed with the refined bio oil 86 to create road asphalt 91. An amount of the petroleum asphalt 89 equal to or greater than the refined bio oil 86 by volume, is mixed with the refined bio oil 86 to produce the road asphalt 91.

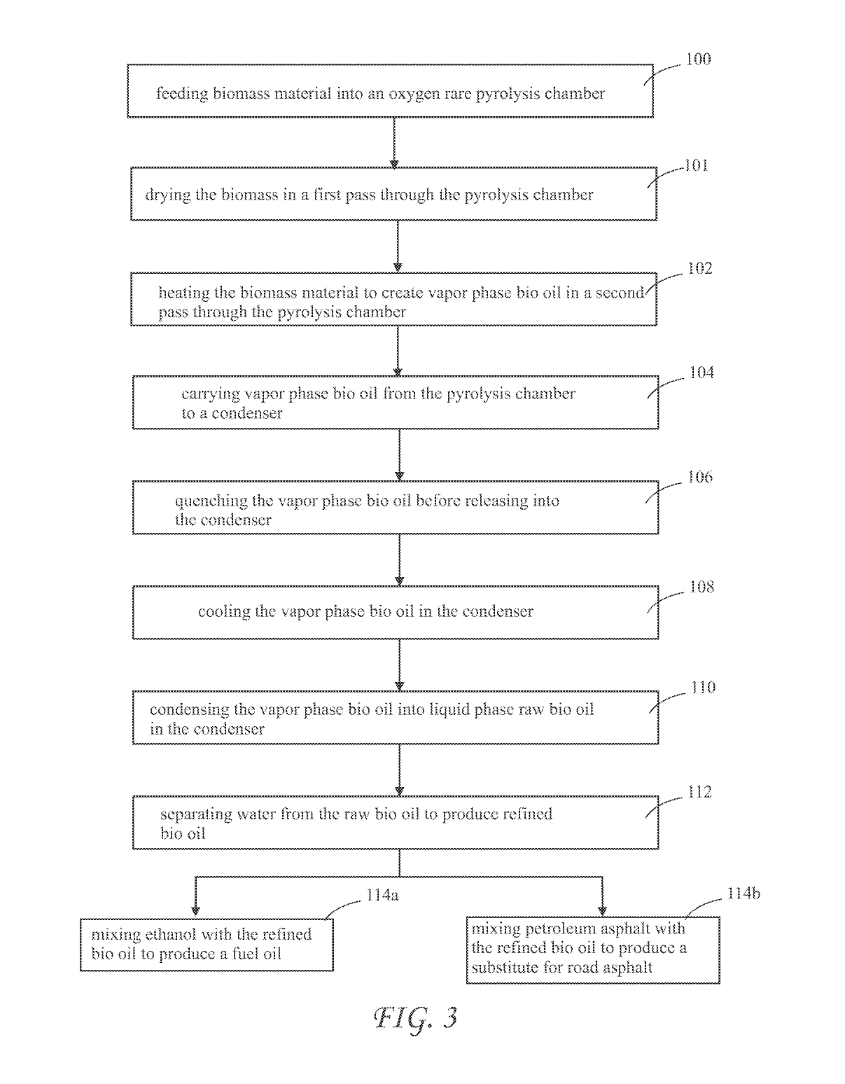

A method for processing biomass according to the present invention is shown in FIG. 3. The method includes feeding biomass material into an oxygen rare torrefaction/drying chamber at step 100, drying the biomass in a first pass through the torrefaction/drying chamber in step 101, heating the biomass material to create vapor phase bio oil in a second pass through the torrefaction/drying chamber at step 102, carrying vapor phase bio oil from the torrefaction/drying chamber to a condenser at step 104, quenching the vapor phase bio oil before releasing into the condenser at step 106, cooling the vapor phase bio oil in the condenser at step 108, condensing the vapor phase bio oil into liquid phase raw bio oil in the condenser at step 110, separating water from the raw bio oil to produce refined bio oil at step 112, and either mixing ethanol with the refined bio oil to produce a fuel oil at step 114a, or mixing petroleum asphalt with the refined bio oil to produce a substitute for road asphalt at step 114b.

While the invention herein disclosed has been described by means of specific embodiments and applications thereof, numerous modifications and variations could be made thereto by those skilled in the art without departing from the scope of the invention set forth in the claims.

I claim:

1. A method for producing road asphalt, the method comprising:
feeding biomass into a two pass torrefaction/drying chamber;
drying the biomass to create dry biomass;
heating the dry biomass to create vapor phase bio oil;
carrying the vapor phase bio oil to a condenser;
condensing the bio oil vapor into liquid phase raw bio oil in the condenser;
separating water from the raw bio oil in a separator to produce refined bio oil; and
processing the refined bio oil into a road asphalt.

2. The method of claim 1, wherein drying the biomass comprises passing the biomass through the torrefaction/drying chamber a first time to dry the biomass.

3. The method of claim 2, wherein heating the dry biomass to create vapor phase bio oil comprises passing the biomass through the torrefaction/drying chamber a second time to create the vapor phase bio oil.

4. The method of claim 3, wherein:
passing the biomass through the torrefaction/drying chamber the first time comprises passing the biomass through the torrefaction/drying chamber on a first auger to dry the biomass; and
passing the biomass through the torrefaction/drying chamber the second time comprises passing the biomass through the torrefaction/drying chamber on a second auger fed by the first auger to create the vapor phase bio oil.

5. The method of claim 1, wherein feeding biomass into the two pass torrefaction/drying chamber comprises feeding the biomass into the two pass torrefaction/drying chamber through an air lock.

6. The method of claim 1, further including quenching the vapor phase bio oil before releasing the vapor phase bio oil into the condenser.

7. The method of claim 6, wherein quenching comprises spraying water into the vapor phase bio oil before releasing the vapor phase bio oil into the condenser.

8. The method of claim 7, wherein spraying the water into the vapor phase bio oil comprises spraying the water into the vapor phase bio oil, resulting in the raw bio oil including 40 to 50 percent of the water by volume and 50 to 60 percent liquid phase bio oil by volume.

9. The method of claim 1, wherein:
the condenser is a double wall condenser; and
further including providing a coolant flow between the double walls of the condenser to cool the vapor phase bio oil flowing through the center of the condenser.

10. The method of claim 9, wherein providing a coolant flow between the double walls of the condenser comprises providing a flow of cool water between the double walls of the condenser.

11. The method of claim 1, wherein processing the refined bio oil into a useful material comprises mixing the refined bio oil with ethanol to produce a fuel oil.

12. The method of claim 11, wherein mixing the refined bio oil with ethanol to produce a fuel oil comprises mixing one part of the refined bio oil with at least 0.2 parts of the ethanol.

13. The method of claim 11, wherein mixing the refined bio oil with ethanol to produce a fuel oil comprises mixing one part refined bio oil with about 0.2 parts ethanol.

14. The method of claim 1, wherein processing the refined bio oil into a road asphalt comprises mixing at least an equal amount by volume of petroleum asphalt with the refined bio oil to produce the road asphalt.

15. The method of claim 1, wherein processing the refined bio oil into a road asphalt comprises mixing about an equal amount by volume of petroleum asphalt with the refined bio oil to produce the road asphalt.

16. The method of claim 1, wherein feeding biomass comprises feeding dry sawdust.

17. The method of claim 1, wherein feeding biomass into the torrefaction/drying chamber comprises feeding biomass into an oxygen rare torrefaction/drying chamber.

18. The method of claim 1, wherein;
the torrefaction/drying chamber comprises at least three zones:
a first zone nearest to the entry of the biomass feed material;
a second zone in the middle; and
a third zone opposite to the first zone;
and the method further including:
collecting vapor phase bio oil in collectors residing in each zone; and
carrying the collected vapor phase bio oil independently from each collector to corresponding condensers.

19. A method for producing road asphalt from biomass material, the method comprising:
feeding biomass material through an airlock into a first auger residing in a torrefaction/drying chamber;
passing the biomass material through the torrefaction/drying chamber to produce dry biomass material to a second auger residing in the torrefaction/drying chamber;
heating the dry biomass material to create vapor phase bio oil;
carrying the vapor phase bio oil to a condenser;
quenching the vapor phase bio oil with water before releasing the vapor phase bio oil into the condenser;
condensing the bio oil vapor into liquid phase raw bio oil in the condenser;
carrying the liquid phase raw bio oil into a separation tank;
removing water from the liquid phase raw bio oil to produce refined bio oil in the separation tank;
carrying the refined bio oil from the separation tank into a mixing tank;
mixing an amount of ethanol of at least 20 percent by volume of the refined bio oil with the refined bio oil to produce fuel oil; and
releasing fuel oil from the mixing tank.

20. A method for producing road asphalt from biomass material, the method comprising:
feeding biomass material through an airlock into a first auger residing in a torrefaction/drying chamber;
passing the biomass material through the torrefaction/drying chamber to produce dry biomass material to a second auger residing in the torrefaction/drying chamber;
heating the dry biomass material to create vapor phase bio oil;
carrying the vapor phase bio oil to a condenser;
quenching the vapor phase bio oil with water before releasing the vapor phase bio oil into the condenser;
condensing the bio oil vapor into liquid phase raw bio oil in the condenser;
carrying the liquid phase raw bio oil into a separation tank;
removing water from the liquid phase raw bio oil to produce refined bio oil in the separation tank;
carrying the refined bio oil from the separation tank into a mixing tank; and
mixed the refined bio oil with an equal or greater amount of petroleum asphalt by volume to produce the road asphalt.
